(19) United States
(12) Patent Application Publication
(10) Pub. No.: US 2006/0278577 A1
(43) Pub. Date: Dec. 14, 2006

(54) Liquid flow promoter device and liquid ejection apparatus

(75) Inventors: Taisuke Yamamoto, Nagano-ken (JP); Toshio Kumagai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/443,342

(22) Filed: May 31, 2006

(30) Foreign Application Priority Data
May 31, 2005 (JP) 2005-160589

(51) Int. Cl. B01D 21/26

(52) U.S. Cl. 210/512.1

(57) ABSTRACT

In a liquid ejection apparatus, liquid is supplied to a liquid ejection head through a liquid flow promoter device. The liquid flow promoter device includes a liquid passage and a liquid receiving chamber provided in a liquid passage. The liquid receiving chamber is defined by an inner wall surface including a substantially arcuate surface. The liquid flow promoter device also includes a liquid inlet portion through which a liquid is introduced from a portion of the liquid passage upstream from the liquid receiving chamber to the liquid receiving chamber in a tangential direction of the substantially arcuate surface. After having been introduced into the liquid receiving chamber through the liquid inlet portion, the liquid proceeds in the liquid receiving chamber in a manner revolving along the substantially arcuate surface. The liquid flow promoter device further includes a liquid outlet portion through which the liquid is sent from the liquid receiving chamber to a portion of the liquid passage downstream from the liquid receiving chamber after having revolved along the substantially arcuate surface of the liquid receiving chamber. Accordingly, the liquid flow promoter device effectively promotes flow of the liquid.

### CROSS-REFERENCE TO RELATED APPLICATIONS

This application is based upon and claims the benefit of priority from prior Japanese Patent Application No. 2005-160589, filed on May 31, 2005, the entire contents of which are incorporated herein by reference.

### BACKGROUND

The present invention relates to a liquid flow promoter device and a liquid ejection apparatus.

Typically, inkjet printers (hereinafter, printers) are known as liquid ejection apparatuses that eject liquid onto a target. A printer has a carriage that reciprocates and a recording head (a liquid ejection head) in the carriage. Nozzles are formed in the recording head and eject ink (liquid) that has been supplied to the recording head, thus subjecting a printing medium to printing. In this printer, a valve device (for example, a choke valve) is arranged in an ink supply tube or an ink outlet tube, which is an ink passage (a liquid passage). The valve device allows the ink to efficiently flow in the ink passage from upstream to downstream (see, for example, Japanese Laid-Open Patent Publication No. 2001-38925).

FIG. 6 is a cross-sectional view showing a type of a valve device, or a choke valve 60. As shown in FIG. 6, the choke valve 60 has a base 62 and a film 64 formed of flexible material. A recess 61 is defined in a side surface of the base 62. The film 64 is fixed to the side surface of the base 62 to cover the recess 61. A supply port 65 is defined in an inner surface 63 of the recess 61. Ink is sent from an ink cartridge, which is located upstream from the supply port 65, into the recess 61 through the supply port 65. A projection 66 is projected substantially from the center of the inner surface 63 of the recess 61. An outlet port 67 is defined in a distal end of the projection 66. The ink is thus sent from the recess 61 to a recording head, which is located downstream from the outlet port 67, through the outlet port 67. The inner surface 63 of the recess 61 and the backside (the side facing the recess 61) of a flexible portion 64a of the film 64 define a sealed pressure chamber (a liquid receiving chamber) 68, which forms a part of the ink passage.

Thus, in the choke valve 60, the flexible portion 64a of the film 64 flexibly deforms in correspondence with the supply pressure of the ink supplied to the pressure chamber 68 through the supply port 65. Such deformation switches the film 64 between a closed state indicated by the two dot chain lines of FIG. 6 and an open state indicated by the solid lines of the drawing.

However, the ink may form bubbles in the pressure chamber 68 when flowing into the pressure chamber 68. Particularly, if the choke valve 60 is installed in an upright state as in FIG. 6, the bubbles may accumulate in an upper section of the pressure chamber 68. In this case, the bubbles cannot be easily moved downward or discharged from the pressure chamber 68. The bubbles thus form larger bubbles with larger volumes in the pressure chamber 68. Such bubbles escape from the pressure chamber 68 through the outlet port 67 relatively easily. If the escaped bubbles enter the recording head when the printer is in operation, missing dots may occur, hampering effective printing.

### SUMMARY

An advantage of some aspects of the present invention is to provide a liquid flow promoter device and a liquid ejection apparatus that effectively promote a flow of a liquid while suppressing formation of bubbles in a liquid receiving chamber defined in a liquid passage.

An aspect of the present invention provides a liquid flow promoter device including a liquid passage, a liquid receiving chamber, a liquid inlet portion, and a liquid outlet portion. The liquid receiving chamber is provided in the liquid passage, and is defined by an inner wall surface including a substantially arcuate surface. Through the liquid inlet portion, a liquid is introduced from a portion of the liquid passage upstream from the liquid receiving chamber to the liquid receiving chamber in a tangential direction of the substantially arcuate surface. After having been introduced into the liquid receiving chamber through the liquid inlet portion, the liquid proceeds in the liquid receiving chamber in a manner revolving along the substantially arcuate surface. Through the liquid outlet portion, the liquid is sent from the liquid receiving chamber to a portion of the liquid passage downstream from the liquid receiving chamber after having revolved along the substantially arcuate surface of the liquid receiving chamber.

Another aspect of the present invention provides a liquid ejection apparatus including a liquid flow promoter device including a liquid passage, a liquid receiving chamber, a liquid inlet portion, and a liquid outlet portion. The liquid receiving chamber is provided in the liquid passage, and is defined by an inner wall surface including a substantially arcuate surface. Through the liquid inlet portion, a liquid is introduced from a portion of the liquid passage upstream from the liquid receiving chamber to the liquid receiving chamber in a tangential direction of the substantially arcuate surface. After having been introduced into the liquid receiving chamber through the liquid inlet portion, the liquid proceeds in the liquid receiving chamber in a manner revolving along the substantially arcuate surface. Through the liquid outlet portion, the liquid is sent from the liquid receiving chamber to a portion of the liquid passage downstream from the liquid receiving chamber after having revolved along the substantially arcuate surface of the liquid receiving chamber. The liquid ejection apparatus also includes a liquid ejection head that ejects the liquid, and is connected to the liquid outlet portion of the liquid flow promoter device.

If a liquid receiving chamber has a corner portion, bubbles in liquid is likely to be trapped at the corner portion. In this respect, the present invention permits liquid that has entered the liquid receiving chamber to smoothly flow in the liquid receiving chamber along the arcuate surface. Therefore, even if bubbles are mixed in the liquid, the bubbles are conducted out of the liquid receiving chamber through a liquid outlet portion together with the liquid after flowing along the arcuate surface of the liquid receiving chamber with the liquid. Thus, even if a liquid receiving chamber is provided in the liquid passage, liquid is permitted to smoothly flow therethrough without trapping bubbles in the liquid receiving chamber. Also, when the liquid flowing through the liquid passage is replaced by a different type of liquid, the liquid used prior to the replacement is likely to remain in the liquid receiving chamber after the replacement. However, the present invention makes the liquid used prior to the replacement less likely to remain in the liquid receiving chamber.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a portion of an inkjet printer according to an embodiment of the present invention;

FIG. 2 is a front view showing a passage defining body of the printer of FIG. 1;

FIG. 3 is a rear view showing the passage defining body of FIG. 2;

FIG. 4 is an enlarged view showing the vicinity of distal ends of first passages of the printer of FIG. 1;

FIG. 5 is a cross-sectional view taken along line 5-5 of FIG. 2; and

FIG. 6 is a longitudinal cross-sectional view schematically showing a typical choke valve.

### DESCRIPTION OF EXEMPLARY EMBODIMENTS

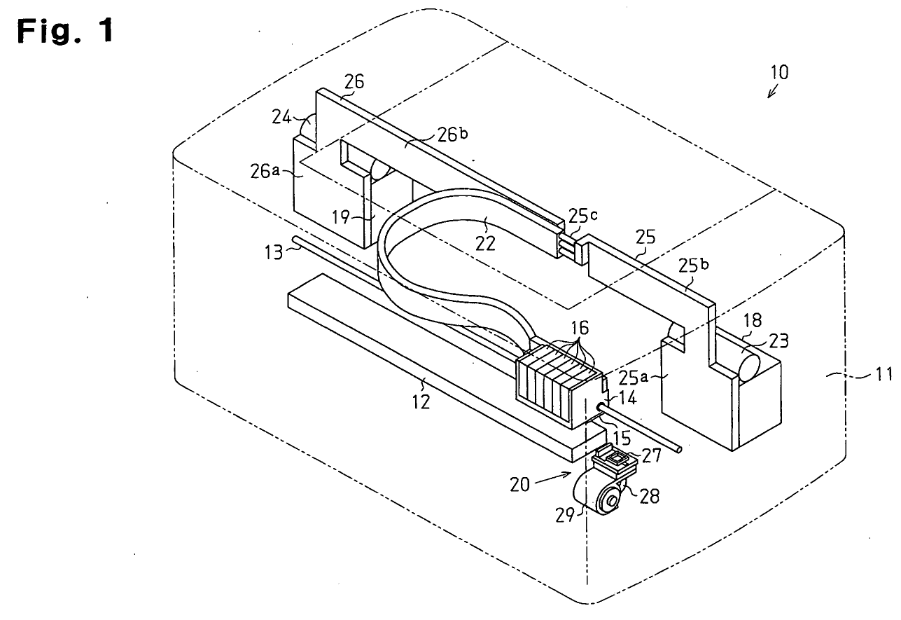

An embodiment of the present invention will now be described with reference to FIGS. 1 to 5.

As shown in FIG. 1, an inkjet printer 10, or a liquid ejection apparatus according to the illustrated embodiment, includes a parallelepiped body casing 11. A platen 12 is arranged in a lower section of the space defined by the body casing 11 and extends in a longitudinal direction of the body casing 11. The platen 12 functions as a support table that supports a sheet of paper, or a target. The sheet of paper is thus supplied through a paper supply tray (not shown) and sent to the exterior of the body casing 11 through a paper discharge tray (not shown) by a paper feeder mechanism (not shown).

A guide shaft 13 is provided in the body casing 11 and above the platen 12. The guide shaft 13 is passed through a carriage 14 in such a manner that the carriage 14 becomes movable. A carriage motor (not shown) is formed in the body casing 11 and connected to the carriage 14 through a timing belt (not shown), which is wound around a pair of pulleys (not shown). This structure allows the carriage 14 to move in a longitudinal direction of the printer 10 through the timing belt while driven by the carriage motor and guided by the guide shaft 13.

A recording head 15, or a liquid ejection head, is formed in a lower surface of the carriage 14. A plurality of ejection nozzles (not shown) are defined in a lower surface of the recording head 15. A plurality of piezoelectric elements (not shown) are arranged in the recording head 15 in correspondence with the nozzles. By exciting the piezoelectric elements, the nozzles are allowed to eject ink (liquid) onto the sheet of paper that has reached a position below the recording head 15. A plurality of sub tanks (valve units) 16 are provided in the carriage 14 for supplying the ink to the recording head 15.

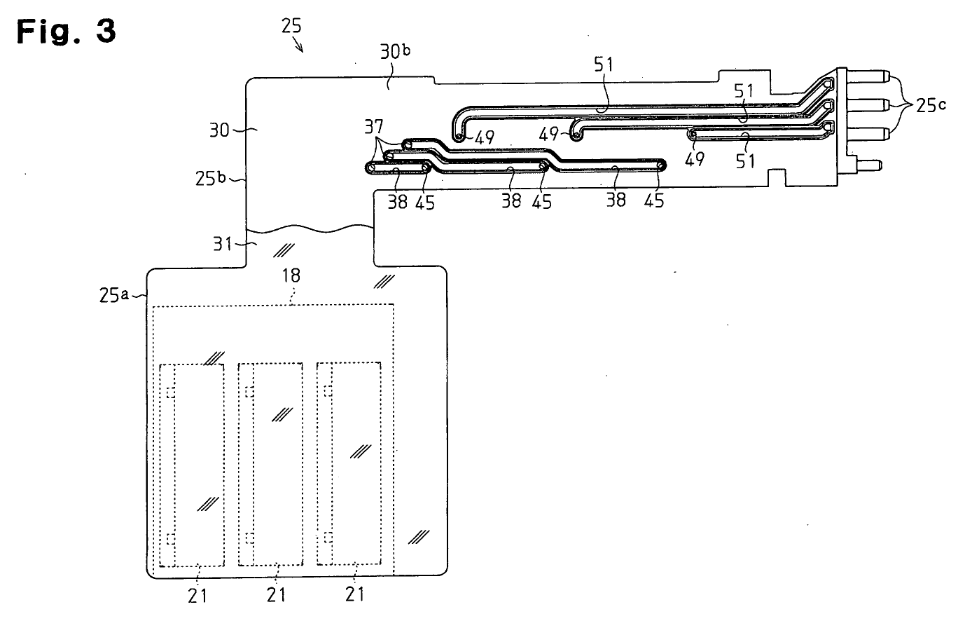

Cartridge holders 18, 19 are fixedly arranged in the body casing 11 at opposite lateral sides of a movement zone of the carriage 14 and outside such zone. A plurality of (in this embodiment, three) ink cartridges 21 (see FIG. 3) are separably received in each of the cartridge holders 18, 19. Accordingly, the printer 10 of the illustrated embodiment is defined as an off-carriage type in which the ink cartridges 21 are maintained at fixed positions, not an on-carriage type in which the ink carriages 21 move integrally with the carriage 14. Each of the ink cartridges 21 accommodates an ink pack (not shown) that retains ink.

In other words, the ink cartridges 21 or the sub tanks 16 are provided by the quantity corresponding to the quantity of the color inks employed by the printer 10 (in the illustrated embodiment, six color inks including, for example, black, yellow, magenta, cyan, light magenta, and light cyan inks). Each of the sub tanks 16 is connected to the ink cartridge 21 containing the corresponding color ink through an ink supply tube ribbon 22. The sub tank 16 thus temporarily retains the ink that has supplied from the corresponding ink cartridge 21. The pressure of the ink is then adjusted to a predetermined level before the ink is supplied to the recording head 15.

Pressurization pumps 23, 24, each of which is formed by a bellows pump, are arranged in the body casing 11 and above the corresponding cartridge holders 18, 19. A first passage defining body 25 is supported by the cartridge holder 18 at a position facing the platen 12 and a second passage defining body 26 is supported by the cartridge holder 19 at a position facing the platen 12. Each of the first and second passage defining bodies 25, 26 serves as a liquid flow promoter device and is connected to the corresponding ink cartridges 21. Specifically, the pressurization pump 23, 24 operates to supply pressurized air into the ink cartridges 21. This flexibly deforms the ink packs retained in the ink cartridges 21 in a squeezing manner, thus sending the ink from the ink cartridges 21 to the corresponding passage defining bodies 25, 26.

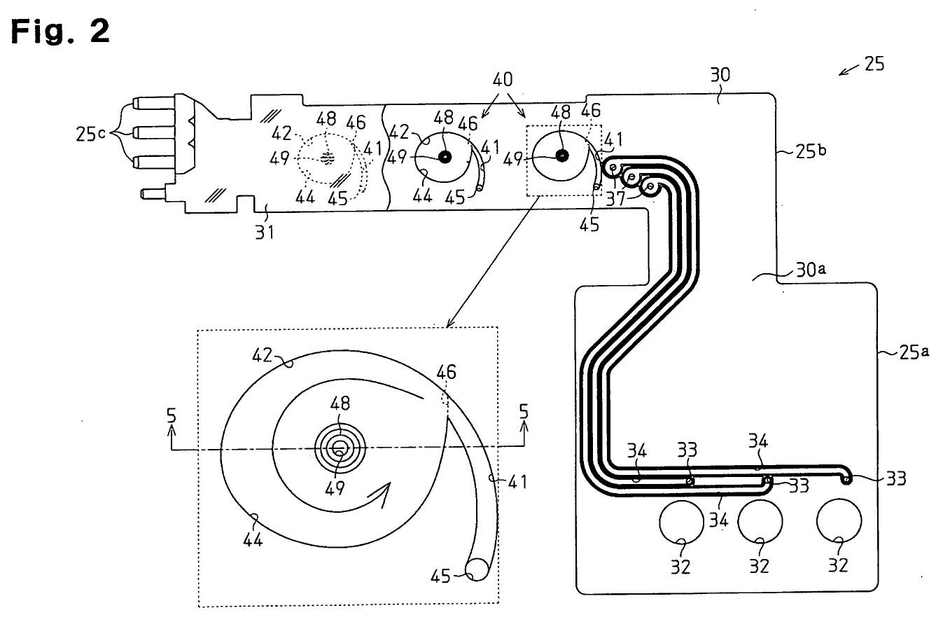

The passage defining body 25 includes a joint portion 25a and an extended portion 25b, and the passage defining body 26 includes a joint portion 26a and an extended portion 26b. Each of the joint portions 25a, 26a is shaped like a flat, substantially rectangular plate. Each of the extended portions 25b, 26b extends from an upper end of the corresponding one of the joint portions 25a, 26a to the center of the space in the body casing 11. Three types of ink passages (first passages 34, second passages 38, and third passages 51: see FIGS. 2 and 3) are defined in the joint portions 25a, 26a and the extended portions 25b, 26b as liquid passages. The ink is thus supplied to the ink cartridges 21 through the first, second, and third passages 34, 38, 51. A proximal end of the ink supply tube ribbon 22 is connected to the distal ends of the extended portions 25b, 26b. Six ink passages (not shown) are defined in the ink supply tube ribbon 22 and each of the ink passages communicates with the corresponding ones of the passages 34, 38, 51, which are defined in the passage defining bodies 25, 26. The configuration of each passage defining body 25, 26 will be explained in detail later, together with the configurations of (in this embodiment, three) choke valves (valve devices) 40.

A distal end of the ink supply tube ribbon 22 is connected to the sub tanks 16 in the carriage 14 through a connection member (not shown) in which six ink passages (not shown) are defined, like the ink supply tube ribbon 22. Thus, by the force generated by the pressurized air supplied from the pressurization pumps 23, 24, the ink is sent from each ink cartridge 21 to the corresponding ink passage (the corresponding first, second, and third passages 34, 38, 51), which are defined in each passage defining body 25, 26, and then to the corresponding ink passage of the ink supply tube ribbon 22. Subsequently, the ink flows into the corresponding ink passage of the connection member and reaches the associated sub tank 16. The ink is thus supplied to the corresponding nozzle of the recording head 15.

A cleaning mechanism 20 is arranged in the body casing 11 and below the carriage 14. The cleaning mechanism 20 removes and discharges ink with increased viscosity from the nozzles as waste liquid. The cleaning mechanism 20 has a cap 27, a suction pump 29, and an ink drainage tube 28 that connects the cap 27 to the suction pump 29. The cap 27 is capable of sealing the nozzle surface of the recording head 15. The suction pump 29 is actuated when the nozzle surface of the recording head 15 is sealed by the cap 27. This draws the ink as the waste liquid from the nozzles of the recording head 15. The ink is then sent to a waste liquid tank (not shown) through the cap 27 and the ink drainage tube 28.

The first and second passage defining bodies 25, 26, each of which serves as a liquid flow promoter device, will hereafter be explained with reference to FIGS. 2 to 5. In the description, the term “upward” refers to an upward direction as viewed in FIGS. 2 to 5. The first and second passage defining bodies 25, 26 are different from each other only in that the components of the first passage defining body 25, including a connecting portion at which the first passage defining body 25 is connected to the ink supply tube ribbon 22 and the ink passages, are symmetrical to the corresponding components of the second passage defining body 26. That is, in the other aspects, the first and second passage defining bodies 25, 26 are configured identically to each other. The following description thus focuses on the first passage defining body 25.

The first passage defining body 25 includes a base 30 formed of synthetic resin and a film 31 formed of thermoplastic resin. The film 31 is fixed to a front surface 30a and a back surface 30b of the base 30. Also, as has been described, the joint portion 25a and the extended portion 25b are formed in the first passage defining body 25. The extended portion 25b extends from the upper end of the joint portion 25a in a shape bent to the left. The extended portion 26b of the second passage defining body 26 extends from the upper end of the joint portion 26a in a shape bent to the right. Thus, with the first and second passage defining bodies 25, 26 aligned along a line as illustrated in FIG. 1, the distal ends of the extended portions 25b, 26b are opposed to each other at a position intermediate between the first and second passage defining bodies 25, 26.

The joint portion 25a is formed in a square shape. A plurality of (in this embodiment, three) through holes 32 are defined in a lower portion of the base 30 corresponding to the joint portion 25a and aligned along a horizontal line. A tube (not shown) for supplying the pressurized air is passed through each of the through holes 32. A plurality of (in this embodiment, three) communication bores 33 are provided above the corresponding through holes 32 and communicate with corresponding ink needles (not shown) arranged in the cartridge holder 18. Further, the three first passages 34 (liquid inlet portions) are defined like grooves in the joint portion 25a and extend continuously from the corresponding communication bores 33. Each of the first passages 34 extends to the extended portion 25b formed continuously from the joint portion 25a. A distal end (a downstream end) of each first passage 34 is located at a position closer to an end (the right end as viewed in FIG. 2) of the extended portion 25b.

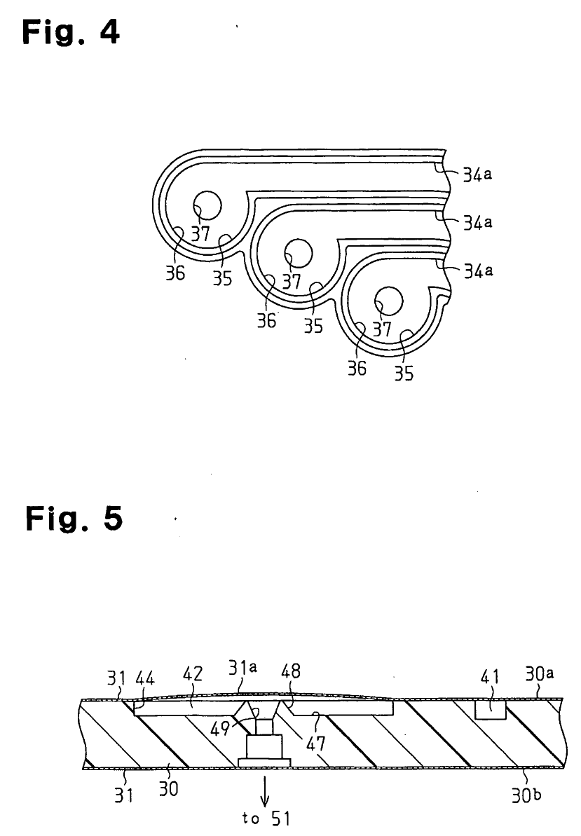

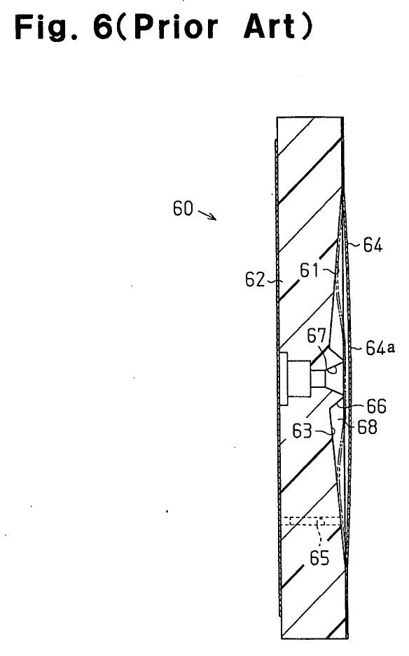

FIG. 4 is an enlarged view showing the vicinity of the distal ends (the downstream ends) of the first passages 34. As shown in the drawing, an ink receiving chamber 35, or a liquid receiving chamber, is defined in the distal end of each first passage 34 and continuously from the first passage 34. Each of the ink receiving chambers 37 has a circular cross-sectional shape. In the illustrated embodiment, a distal portion 34a of each first passage 34 is arranged in the corresponding ink receiving chamber 35 in such a manner as to introduce the ink into the ink receiving chamber 35 in a tangential direction of an inner wall surface 36 of the ink receiving chamber 35. A through hole 37 (a liquid outlet portion) extends through the center of the bottom of each ink receiving chamber 35 and has an opening corresponding to the back surface 30b. In other words, each of the first passages 34 communicates with the corresponding through hole 37 through the associated ink receiving chamber 35.

As shown in FIG. 3, the three second passages 38 are defined like grooves in the back surface 30b of the base 30. Each of the second passages 38 communicates with the corresponding one of the first passages 34 through the associated through hole 37. Each of the through holes 37 is arranged with respect to the associated ink receiving chamber 35 in such a manner as to send the ink out of the ink receiving chamber 35 in a direction (a direction perpendicular to the sheet surface of FIG. 2) different from the direction in which the ink flows in each first passage 34 (a direction parallel with the sheet surface of FIG. 2).

A plurality of (in this embodiment, three) choke valves 40 are defined in the extended portion 25b of the base 30 and arranged in parallel in a longitudinal direction of the extended portion 25b. That is, an elongated ink inlet line 41 and a substantially circular ink receiving chamber 42 are defined at each of three separate positions on a section of the front surface 30a of the base 30 corresponding to the extended portion 25b. Each of the ink receiving chambers 42 communicates with the corresponding one of the ink inlet lines 41. Each ink receiving chamber 42 is partly defined by an inner wall surface 44 curved in a manner defining an involute surface. A portion of the surface defining each ink inlet line 41 is defined continuously from the inner wall surface 44 of the corresponding ink receiving chamber 42 and curved in a manner defining an involute surface, like the inner wall surface 44. The distal end (the downstream end) of each second passage 38, which is defined in the back surface 30b of the base 30, has an opening defined in an inner surface of a proximal end (opposed to the ink receiving chamber 42) of the corresponding ink inlet line 41. The opening defines a supply port 45 through which the ink is supplied to the ink inlet line 41. The width of each ink inlet line 41 becomes gradually smaller from the proximal end (an upstream end) of the ink inlet line 41, in which the support port 45 is provided, to a downstream portion. In the downstream portion of each ink inlet line 41, a connection port 46 is defined as a connecting portion between the ink inlet line 41 and the corresponding ink receiving chamber 42.

FIG. 5 is a cross-sectional view taken along line 5-5 of FIG. 2. As shown in FIG. 5, each of the ink receiving chamber 42 is partly defined by a flat inner bottom surface 47. A projection 48 is projected substantially from the center of the inner bottom surface 47. An outlet port 49 (a liquid outlet portion) is defined in the distal end of the projection 48. The ink is thus sent out of the ink receiving chamber 42 through the outlet port 49. The third passages 51 are defined like grooves in the back surface 30b of the base 30 and each have an upstream end defined by the outlet port 49 of the corresponding ink receiving chamber 42. The third passages 51 extend toward the distal end (the right end as viewed in FIG. 3) of the extended portion 25b. Each of the third passages 51 communicates with a connection port 25c at which the third passage 51 is connected to the ink supply tube ribbon 22. The outlet port 49 is arranged with respect to the corresponding ink receiving chamber 42 in such a manner as to send ink out of the ink receiving chamber 42 in a direction (a direction perpendicular to the sheet surface of FIG. 2) different from the flowing direction of the ink in each ink inlet line 41 (a direction parallel with the sheet surface of FIG. 2).

The first passages 34, the ink receiving chambers 35, and the ink inlet lines 41 and the ink receiving chambers 42 of the choke valves 40, which are defined in the front surface 30a of the base 30, are sealed through thermal welding of the film 31, or a flexible valve body, on the front surface 30a of the base 30. Likewise, the second passages 38 and the third passages 51 defined in the back surface 30b of the base 30 are sealed through thermal welding of the film 31, the flexible valve body, on the back surface 30b of the base 30.

As illustrated in FIG. 5, in each of the choke valves 40, the ink receiving chamber 42 is defined as a sealed pressure chamber by the film 31 (specifically, the flexible portion 31a corresponding to the ink receiving chamber 42), which has been thermally welded to the base 30. More specifically, the film 31 is thermally welded to the portions of the front surface 30a of the base 30 except for the portions corresponding to the ink inlet lines 41, the ink receiving chambers 42, and the projections 48. The flexible portion 31a of the film 31 corresponding to each of the ink receiving chambers 42 is flexibly deformed to switch between an open-valve state and a closed-valve state by receiving the supply pressure of the ink applied to the ink receiving chamber 42 (the pressure chamber). In the open-valve state, each flexible portion 31a opens the corresponding supply port 45 and the associated outlet port 49. In the closed-valve state, the flexible portion 31a closes the outlet port 49.

Each of the choke valves 40 is arranged as an upright type valve device. That is, the inner bottom surface 47 of the ink receiving chamber 42 and the film 31 extend parallel with each other in vertical directions. The outlet port 49 of each ink receiving chamber 42 extends through the base 30 in a horizontal direction.

Next, the operation of the printer 10 will be explained, focusing on operations of the first and second passage defining bodies 25, 26 serving as the liquid flow promoter devices.

To start printing, the pressurization pumps 23, 24 are first actuated to supply ink from the ink cartridges 21 to the recording head 15. Specifically, the pressurization pumps 23, 24 operate to send pressurized air into each of the ink cartridges 21 through the associated air supply tube, which is passed through the corresponding through hole 32. This squeezes the ink pack in the ink cartridge 21, sending the ink from the ink cartridge 21 to the corresponding passage defining body 25, 26. Since the first and second passage defining bodies 25, 26 operate in the same manners, only operation of the first passage defining body 25 will be explained in the following.

The ink is supplied from each of the cartridges 21 to the corresponding first passages 34 of the first passage defining body 25 through an ink needle (not shown) provided in the cartridge holder 18 and the associated communication bore 33. The ink then proceeds downstream in the first passage 34 and enters the associated ink receiving chamber 35 through the distal portion 34a of the first passage 34. The distal portion 34a of the first passage 34 is arranged with respect to the ink receiving chamber 35 in a tangential direction of the inner wall surface 36 of the ink receiving chamber 35. This arrangement permits the ink to smoothly flow from the first passage 34 (the distal portion 34a) into the ink receiving chamber 35.

In each ink receiving chamber 35, the ink moves in a manner revolving along the inner wall surface 36, which has an arcuate cross-sectional shape. The ink then flows into the corresponding second passage 38, which is defined in the back surface 30b, through the through hole 37 extending through the center of the ink receiving chamber 35. In other words, the inner wall surface 36 of each ink receiving chamber 35 formed in a circular shape promotes the flow of the ink from the corresponding first passage 34 to the through hole 37. Further, small bubbles from each first passage 34 are prevented from being trapped particularly in the vicinity of the inner wall surface 36 of the corresponding ink receiving chamber 35. The bubbles thus flow out of the ink receiving chamber 35 through the through hole 37, together with the ink.

Subsequently, the ink flows from each of the second passages 38 into the ink inlet line 41 of the corresponding choke valve 40 through the supply port 45. The ink thus proceeds downstream in the ink inlet line 41 (toward the associated ink receiving chamber 42). As has been described, the width of each ink inlet line 41 becomes gradually smaller from the upstream end, or the proximal end corresponding to the supply port 45, to the downstream end corresponding to the connection port 46, or the connecting portion at which the ink inlet line 41 is connected to the associated ink receiving chamber 42. This increases the flow rate of the ink at the connecting portion (the connection port 46), and the ink rapidly flows into the ink receiving chamber 42. Further, since a portion of the surface defining the ink inlet line 41 is curved to define an involute surface extending continuously from the inner wall surface 44 of the ink receiving chamber 42, the ink is smoothly introduced from the ink inlet line 41 into the ink receiving chamber 42.

After having entered the ink receiving chamber 42 at a sufficiently increased flow rate, the ink proceeds along the inner wall surface 44 of the ink receiving chamber 42, which defines the involute surface, toward the center (the outlet port 49) of the ink receiving chamber 42 in such a manner as to form a vortex (as indicated by the arrow of FIG. 2). In other words, the inner wall surface 44 of each ink receiving chamber 42 defining the involute surface promotes the flow of the ink from the associated ink inlet line 41 to the outlet port 49. Further, since the inner wall surface 44 of each ink receiving chamber 42 is smoothly curved, small bubbles contained in the ink are prevented from being trapped particularly in the vicinity of the inner wall surface 44. The bubbles are thus sent out of the ink receiving chamber 42 through the outlet port 49, together with the ink. The ink is then supplied from the outlet port 49 to the corresponding sub tank 16 received in the carriage 14, in which the recording head 15 is located, through the corresponding ink passage in the ink supply tube ribbon 22.

The illustrated embodiment has the following advantages.

(1) In the illustrated embodiment, the inner wall surface 36 of each ink receiving chamber 35 has a circular shape (an arcuate cross-sectional shape). The ink is thus introduced into the ink receiving chamber 35 in a tangential direction of the inner wall surface 36 (from the distal portion 34a of the corresponding first passage 34). This promotes the flow of the ink at a point where the flow direction of the ink is changed from the first passage 34 to the second passage 38, which is the ink receiving chamber 35. The bubbles in the ink are thus prevented from being trapped at the point where the ink flow direction is changed (specifically, the vicinity of the inner wall surface 36 of the ink receiving chamber 35). Therefore, the bubbles are easily sent out of the ink receiving chamber 35 to the second passage 38. That is, although the bubbles easily accumulate in a vertical upper section of each ink receiving chamber 35, the bubbles are efficiently discharged from the ink receiving chambers 35. This suppresses a printing problem such as missing dots.

(2) In the illustrated embodiment, the ink receiving chamber 42 of each choke valve 40 has the inner wall surface 44 that defines the involute surface extending continuously from the corresponding ink inlet line 41. This promotes the flow of the ink in the ink receiving chamber 42 from the ink inlet line 41 to the outlet port 49. That is, as in the advantage (1), small bubbles contained in the ink are prevented from being trapped in the vicinity of the inner wall surface 44 of each ink receiving chamber 42. The ink is thus easily discharged from the ink receiving chamber 42 into the corresponding third passage 51. This suppresses a printing problem. Particularly, since each of the choke valves 40 is installed upright, the bubbles easily accumulate in a vertical upper section of the ink receiving chamber 42. However, in the illustrated embodiment, the bubbles are efficiently discharged from the choke valves 40 regardless of the upright position of the choke valve 40.

(3) In the illustrated embodiment, the width of each ink inlet line 41 becomes gradually smaller from the upstream end, or the proximal end corresponding to the supply port 45, to the downstream end corresponding to the connection port 46, or the connecting portion at which the ink inlet line 41 is connected to the associated ink receiving chamber 42. This structure increases the flow rate of the ink at the connecting portion (the connection port 46), and the ink rapidly flows into the ink receiving chamber 42. In other words, the ink smoothly flows in each ink receiving chamber 42 in a further desirable manner, and the bubbles are efficiently discharged from the ink receiving chamber 42.

(4) In the illustrated embodiment, the inner bottom surface 47 of the ink receiving chamber 42 of each choke valve 40 is formed flat. This creates a sufficient volume of the ink receiving chamber 42, or the pressurization chamber compared to, for example, a case of a choke valve in which an ink receiving chamber has a tapered cross-sectional shape, or has a depth that becomes gradually greater from the inner wall surface to the center. Therefore, the flow of the ink in the printer 10 is maintained in a desirable state, the response of the choke valve 40 as a valve device is improved. A tapered bottom surface is preferable for effectively moving bubbles from the vicinity of the inner wall surface 44 of the ink receiving chamber 42 to an outlet port 49 defined at the center of the ink receiving chamber, and discharging the bubbles through the outlet port 49 . . . . In the illustrated embodiment, discharge of the bubbles from each ink receiving chamber 42 is facilitated by the shape of the inner wall surface 44 of the ink receiving chamber 42 and the flow direction of the ink introduced into the ink receiving chamber 42, which is the tangential direction of the inner wall surface 44. This allows the inner bottom surface 47 of each ink receiving chamber 42 to become flat, while ensuring the facilitated discharge of the bubbles and the improved response of each choke valve 40.

The illustrated embodiment may be modified in the following forms.

In the illustrated embodiment, the width of each ink inlet line 41 does not necessarily have to become gradually smaller from the proximal end corresponding to the supply port 45 to the connecting portion (the connection port 46) at which the ink inlet line 41 is connected to the ink receiving chamber 42.

In the illustrated embodiment, the projection 48 may be omitted from each choke valve 40. In this case, the outlet port 49 may be defined directly in the inner bottom surface 47 of the choke valve 40.

In the illustrated embodiment, the through holes 37, each of which serves as the liquid outlet portion, may be provided at any suitable positions other than the centers of the ink receiving chambers 35. Similarly, the outlet ports 49, each of which serves as the liquid outlet portion, may be provided at any suitable positions other than the centers of the ink receiving chambers 42.

In the illustrated embodiment, the inner bottom surface 47 of each ink receiving chamber 42 may be shaped in such a manner that the ink receiving chamber 42 has a tapered cross-sectional shape, or that the depth of the ink receiving chamber 42 becomes gradually greater from the vicinity of the inner wall surface 44 to the center of the ink receiving chamber 42. In this case, by the film 31 that flexibly deforms toward the inner bottom surface 47 of the ink receiving chamber 42, the bubbles are gradually displaced from the vicinity of the inner wall surface 44 to the outlet port 49. This facilitates discharge of the bubbles from the ink receiving chamber 42.

In the illustrated embodiment, each of the ink inlet lines 41 does not necessarily have to be formed in such a manner as to define the involute surface. That is, as long as the inner wall surface 44 of each ink receiving chamber 42 is formed to define the involute surface, the flow of the ink in each ink receiving chamber 42 is effectively promoted and the bubbles are efficiently discharged from the ink receiving chamber 42.

In the illustrated embodiment, the inner wall surface 36 of each ink receiving chamber 35 may be shaped in such a manner that the ink receiving chamber 35 has a substantially arcuate cross-sectional shape other than the circular cross-sectional shape. Further, the inner wall surface 44 of each ink receiving chamber 42 may be formed in a substantially arcuate shape other than the shape defining the involute surface. In either case, the ink is introduced into the ink receiving chamber 35, 42 in the tangential direction of the inner wall surface 36, 44. The ink is thus allowed by the inner wall surface 36, 44 to smoothly flow in the ink receiving chamber 35, 42.

In the illustrated embodiment, only the point where the ink flow direction is changed between the first passage 34 and the second passage 38 or the choke valve 40 may be configured as the ink receiving chamber 35, 42 having the inner wall surface 36, 44, which is shaped in such a manner as to promote the flow of the ink in the ink receiving chamber 35, 42.

In the illustrated embodiment, the liquid flow promoter device according to the present invention is embodied as each of the passage defining bodies 25, 26. However, the liquid flow promoter device may be formed by any other suitable fluid passages. For example, the liquid flow promoter device may be formed by a valve device that is configured identically to the choke valve 40 of the illustrated embodiment and arranged in the ink drainage tube (the liquid passage) 28 of the cleaning mechanism 20. Alternatively, the liquid flow promoter device may be provided in a corner portion of a liquid passage corresponding to a point where the ink flow direction is changed and bubbles are easily trapped.

In the illustrated embodiment, each flexible valve body may be formed by, for example, a rubber sheet, instead of the film 31.

In the illustrated embodiment, the present invention is applied to the off-carriage type inkjet printer 10. However, the present invention may be applied to a valve device arranged in an ink drainage tube (a liquid passage) of an on-carriage type inkjet printer.

In the above illustrated embodiment, the present invention is applied to the printer 10, which ejects ink. However, the present invention may be applied to other types of liquid ejection apparatuses. For example, the present invention may be applied to printing machines including fax machines and copy machines, a liquid injecting apparatus for injecting liquid such as electrode material or color material used for manufacturing liquid crystal displays, electro luminescent displays and surface light emitting displays. The present invention may also be applied to liquid injecting apparatus for injecting biological organic matter used for manufacturing biochips. Alternatively, the present invention may be applied to sample injecting apparatus such as a precision pipette. Also, the present invention may be applied to devices that use liquid other than ink.

What is claimed is:

1. A liquid flow promoter device comprising:
a liquid passage;
a liquid receiving chamber provided in the liquid passage, the liquid receiving chamber being defined by an inner wall surface including a substantially arcuate surface;
a liquid inlet portion through which a liquid is introduced from a portion of the liquid passage upstream from the liquid receiving chamber to the liquid receiving chamber in a tangential direction of the substantially arcuate surface, wherein, after having been introduced into the liquid receiving chamber through the liquid inlet portion, the liquid proceeds in the liquid receiving chamber in a manner revolving along the substantially arcuate surface; and
a liquid outlet portion through which the liquid is sent from the liquid receiving chamber to a portion of the liquid passage downstream from the liquid receiving chamber after having revolved along the substantially arcuate surface of the liquid receiving chamber.

2. The device according to claim 1, wherein the substantially arcuate surface of the liquid receiving chamber is defined by an involute surface, and wherein the liquid is sent from a substantial middle of the liquid receiving chamber to the portion of the liquid passage downstream from the liquid receiving chamber through the liquid outlet portion.

3. The device according to claim 2, wherein the surface defining the liquid inlet portion includes an involute surface extending continuously from the involute surface of the liquid receiving chamber.

4. The device according to claim 1, wherein the liquid inlet portion has a shape that is gradually tapered from an upstream end to a downstream end.

5. The device according to claim 1, wherein the inner wall surface of the liquid receiving chamber further includes a flat inner bottom surface.

6. The device according to claim 1, wherein the substantially arcuate surface of the liquid receiving chamber has a substantially arcuate vertical cross-sectional shape.

7. A liquid ejection apparatus comprising:
a liquid flow promoter device including:
a liquid passage;
a liquid receiving chamber provided in the liquid passage, the liquid receiving chamber being defined by an inner wall surface including a substantially arcuate surface;
a liquid inlet portion through which a liquid is introduced from a portion of the liquid passage upstream from the liquid receiving chamber to the liquid receiving chamber in a tangential direction of the substantially arcuate surface, wherein, after having been introduced into the liquid receiving chamber through the liquid inlet portion, the liquid proceeds in the liquid receiving chamber in a manner revolving along the substantially arcuate surface; and
a liquid outlet portion through which the liquid is sent from the liquid receiving chamber to a portion of the liquid passage downstream from the liquid receiving chamber after having revolved along the substantially arcuate surface of the liquid receiving chamber; and
a liquid ejection head that ejects the liquid, the liquid ejection head being connected to the liquid outlet portion of the liquid flow promoter device.
